(19) United States
(12) Patent Application Publication
(10) Pub. No.: US 2019/0228593 A1
(43) Pub. Date: Jul. 25, 2019

(54) TOLL ROAD NETWORK TRAFFIC INFORMATION COLLECTION AND GUIDANCE SYSTEM BASED ON ROUTE IDENTIFICATION SYSTEM

(71) Applicant: SOUTH CHINA UNIVERSITY OF TECHNOLOGY, Guangdong (CN)

(72) Inventors: Weiming LIU, Guangdong (CN); Bei ZHOU, Guangdong (CN); Guangguang HAN, Guangdong (CN); Fangping ZHU, Guangdong (CN); Chao WANG, Guangdong (CN); Chunhua LIU, Guangdong (CN); Shizhi XIE, Guangdong (CN); Weijie TANG, Guangdong (CN); Yuyang SHI, Guangdong (CN); Pengbo LIU, Guangdong (CN); Yu LIANG, Guangdong (CN); Jinmu HUANG, Guangdong (CN); Guangwen QIN, Guangdong (CN); Xiao DENG, Guangdong (CN); Mindong XIA, Guangdong (CN)

(73) Assignee: SOUTH CHINA UNIVERSITY OF TECHNOLOGY, Guangdong (CN)

(21) Appl. No.: 15/999,838

(22) PCT Filed: Dec. 21, 2016
(86) PCT No.: PCT/CN2016/111386

§ 371 Date: Aug. 20, 2018

(30) Foreign Application Priority Data
Feb. 18, 2016 (CN) 201610091169.1

(51) Int. Cl. G07B 15/06; G06Q 50/30; G06Q 20/32

(52) U.S. Cl. CPC G07B 15/063; G06Q 2240/00; G06Q 20/3278; G06Q 50/30

(57) ABSTRACT

The invention discloses a toll road network traffic information collection and guidance system based on a route identification system, comprising toll road exit and entry toll lane systems, a networked toll center system, a 5.8 G route identification station, a 5.8 G route identification station monitoring system, a dual-frequency pass card for MTC vehicles, an OBU and a non-cash payment card for ETC vehicles, an in-vehicle multimedia terminal and a traffic information processing system. Collection of route identification, traffic information and vehicle driving state information, and traffic information pushing are implemented using the 5.8 GHz route identification station, the dual-frequency pass card and OBU containing a Bluetooth module and an OBU, and the in-vehicle multimedia terminal; processing and predication of information such as travel time, traffic flow, travel velocity, traffic state, and vehicle location on toll road sections are implemented using a method of combining cloud computing with 5.8 G route identification station distributed calculating, providing accurate and reliable traffic information ahead to a road user in real-time.

### BACKGROUND OF THE INVENTION

### Technical Field

The present invention relates to a toll road traffic information collection and guidance technology, and more particularly, to a toll road network traffic information collection and guidance system based on a route identification system.

### Background

Real-time, effective, rapid and accurate traffic information collection and processing are the basis for ensuring a normal operation of a toll road, but different road users and managers have different information requirements and real-time requirements. The road users need to know the traffic state ahead and the travel time in real-time during driving; a toll collection management department needs to collect the information such as a number of wheels, a number of axles and a license plate number of a vehicle, a model of a passenger car, an axle weight and a total weight of a freight car, a driving route, a driving distance, and whether there is cheating on toll road entry and exit, so as to implement toll collection according to the driving distance, and the model and weight of the car. A traffic investigation department needs to collect the information such as a traffic flow of a road section by models, a mean velocity, a mean driving time, a mean driving distance and a standard axle load, so as to provide support for macro decision-making of transportation planning. A traffic management department needs to collect the information such as a real-time traffic flow, a vehicle velocity, a traffic density, a travel time and a license plate number, a license plate color, a velocity, an accelerated velocity, a steering angle, exhaust emissions, steering and braking information of each vehicle, determines the information like whether the vehicle has overspeed, over-limited or overloaded conditions, fatigue driving, traffic accident and traffic congestion, and estimate and predict a road traffic state and a vehicle driving location, so as to provide data support for autonomous driving, road monitoring and public transportation information services.

At present, the mode of expressway traffic information collection and processing in China is still at a low level, which is mainly relied on vehicle detectors arranged on expressway lanes, such as a coil detector, a microwave detector and a video detector, and can only collect the traffic flow and the vehicle velocity. Since the information collected by the vehicle detector is single, with low reliability and is difficult to maintain, the information collection does not have real-time performance, and the arrangement density is very low, which is too far to meet the information requirements of expressway management.

At present, most expressways in China are toll roads (the toll road mentioned in this application refers an expressway with a toll station), which implements computer-networked toll in provinces, and mainline toll stations have been removed. The total mileages of networked toll roads range from 2,000 to 8,000 kilometers. In order to solve the problem about identifying the vehicles on such large and complicated ambiguous routes of the road network, and to achieve the purpose of accurately charging and accurately separating by a vehicle model or weight according to the actual driving distance of the vehicle, Sichuan, Zhejiang and Guangdong have successfully implemented an ambiguous route identification system based on an RFID technology at present, and the use condition is good at current. At the same time, the nationwide networking of Electronic Toll Collection (ETC) for expressways was achieved throughout China in 2015, more than 21 million users were checkless throughout the whole country by one card. The ETC toll has become the mainstream toll collection way of expressways. Therefore, it will become a trend to implement the route identification of ETC vehicles and MTC vehicles by using 5.8 GHz expressway electronic toll frequency band specified by the national standard. With the rapid development of networking toll of the toll roads and the Internet of Vehicles, since a dual-frequency pass card and an OBU are needed as media to implement the accurate toll collection and separation of vehicles, it is only necessary to install 5.8 G route identification stations on the toll road according to the information collection requirements to achieve real-time traffic information collection, which will replace the traditional collection way of the traffic information, fully reflects the information interaction mode between the road and the vehicle in the Internet of Vehicles, and adapts to the development of the times.

In order to save labor cost, control overloaded vehicles and prevent toll corruption, at present, an automatic vehicle model identification system and a license plate identification system have been generally used at an entry of a toll road in China to achieve self-service card issuance. A weighing device has been installed at the entry to prevent the overloaded vehicles from entering the expressway to endanger the traffic safety of the expressway and the safety of road facilities; and the weighing device and the license plate identification system have been installed at an exit to achieve toll collection by weights and prevent the vehicles from cheating by changing cards. In this way, complete information related to the vehicle will be collected by a toll road exit (entry) lane system.

At present, with respect to MTC users (manual toll), a 433 MHz frequency band is used in the ambiguous route identification system implemented in Sichuan, Zhejiang and Guangdong provinces to identify routes, the 433 MHz frequency band belongs to long-distance information transmission, has strong diffraction ability, is easy to be disturbed by signals from other frequency bands, and has high string rate, resulting in high route identification failure rate. Moreover, the 433 MHz frequency band is not a dedicated frequency band of national standard for expressways, and does not have a long-term application prospect. With respect to ETC users, a 5.8 GHz frequency band is used in the ambiguous route identification system, which conforms to the standard for expressway electronic toll frequency band regulated by the state, but two different frequency bands of 433 MHz and 5.8 GHz are used in the current route identification system, and two sets of identification devices of different frequency bands need to be installed on the identification road section, which increases the construction cost of the system, wastes the construction resources, and reduces the reliability of the system. In the meanwhile, a composite pass card is used in the current route identification system, which requires a dual-frequency reader-writer to respectively read and write entry information and route information, and is easy to cause the problems such as long time of card reading and writing, high failure rate of card reading and writing, reduced lane capacity and short service life of the composite pass card, and the existing system (ambiguous route identification not based on an RFID technology) cannot be smoothly transited to the ambiguous route identification system based on the RFID technology.

At present, the traffic information collection and processing mode based on a toll system is to import the data collected by the toll road exit (entry) lane systems into a networked toll center for centralized processing, but the expressway road network is huge and complicated, and the information that can only be obtained at the exit of the toll station has a serious hysteretic nature, so that the traffic information that can be provided is substantially valueless to travelers, and is generally used for subsequent statistical analysis. Moreover, the centralized processing mode has extremely high requirements on a central device and network, and a huge number of uploaded data volume is needed. When the road section suffers power outage, network failure or system device damage, it is likely to cause large-range data missing or information disorders. However, the toll road exit (entry) lane systems and the 5.8 G route identification station are used as collection and processing clouds in the present invention, which can effectively solve these problems through a distributed structure.

At present, the traffic information collection based on a cloud platform mainly obtains information through an on-board GPS or a mobile terminal, which mainly aims at the current situation that a large number of taxis and buses in an urban road network have been installed with an on-board GPS monitoring device, while very few of these vehicles are distributed in an expressway network. Moreover, the on-board GPS or the mobile terminal can only obtain state information of some vehicles, and cannot cover all the driving vehicles to obtain the required information, which affects the information collection accuracy.

At present, the publishing way of traffic information is mainly to indiscriminately play the information in a wide range through broadcasting, without a target, and the broadcast information is useless to most drivers. During the driving process, road users are mainly concerned about the traffic information of the road ahead, but a variable information board is expensive at present, and the cost for one point is at least 400,000 Yuan generally, so it is rarely arranged in the toll road network. At present, the toll roads in China do not have an inexpensive platform that can provide accurate and effective induction information in real-time.

The present invention, mainly based on the current expressway networked toll system, the current condition and existing problems of the ambiguous route identification system based on an RFID technology, and based on the development requirements on non-stop toll technologies and technologies of the Internet of Vehicles, provides a low-cost, rapid and highly accurate information collection and guidance system that obtains complete traffic information of the road network based on the toll road ambiguous route identification system, which can effectively solve numerous problems to be settled urgently such as ambiguous route identification of the toll road, real-time and complete traffic information collection and processing of the road network, and traffic information providing.

Upon retrieving, it is found that the contents disclosed by the China Patent No. 201410186194.9 titled “Full-Functional Route Identification Toll Double-Source Multi-Frequency Read-Write System and Method for Expressway” show that 840 to 845 MHz or 920 to 925 MHz is used to realize the route identification of ETC vehicles and MTC vehicles instead of the 5.8 GHz frequency band specified by the national standard, the vehicle and the 5.8 G route identification station cannot realize a two-way communication, the traffic information transmitted by the identification station cannot be received, there is no Bluetooth function of the dual-frequency pass card, and the real-time traffic information cannot be transferred to road users. The contents disclosed by the Chinese Patent No. 200710055079.8 titled “Non-Stop Electronic Toll System with Route Identification Function” show that no route identification of MTC vehicles is involved although the 5.8 GHz frequency band is used in the communication between an OBU and a roadside identification unit, the OBU does not have a Bluetooth function, and the real-time traffic information cannot be transferred to road users. The contents disclosed by the Chinese Patent No. 201210143304.4 titled “Ambiguous Route Recognition System with Traffic Information Statistics Function” show that only OBU route identification and traffic information collection problems are involved, but only the traffic flow information of a certain road section at a certain time point, velocity information of a certain vehicle, or time information of a certain vehicle passing by a certain road section are included, and the collected information is incomplete. Moreover, various data information required by the expressways cannot be accurately and effectively provided according to the calculation based on a serial number of the OBU and a timestamp only. Moreover, the route identification of MTC vehicles is not taken into account, the OBU does not have a Bluetooth function, and the real-time traffic information cannot be transferred to road users. The contents disclosed by the Chinese Patent No. 201310145891.5 titled “Method for Collecting Traffic States Based on ETC Device” show that although the information such as a congestion degree, a flow, a travel time and a travel velocity of a road section are obtained, only information of the ETC vehicles is collected, and there are no contents regarding information collection and route identification of the MTC vehicles, and traffic information processing is simple processing conducted according to static data of the vehicles, without real-time dynamics, the OBU does not have a Bluetooth function, and the real-time traffic information cannot be transferred to road users. The contents disclosed by the Chinese Patent No. 201210109000.6 titled “Implementation System and Method for Cloud Calculation and Cloud Service of Road Traffic Information Based on Technology of Internet of Things” show that only road service levels and velocities are estimated by using an on-board GPS and cloud calculation.

### SUMMARY OF THE INVENTION

The present invention, mainly based on the current situation that the ETC toll technology has become the mainstream toll method of toll roads in China, and will gradually replace the manual toll trends, as well as the demands for intelligentized development of the Internet of Vehicles and expressways, proposes a dual-frequency pass card that integrates a non-contact IC card (13.56 MHz), an RFID card (5.8 GHz) and a Bluetooth module circuit into a whole; proposes to adopt a 5.8 GHz route identification station conforming to a national highway electronic toll dedicated frequency band as a traffic information collection and processing cloud, to conduct a two-way communication with an OBU of an ETC vehicle and a dual-frequency pass card of an MTC vehicle to implement the route identification, traffic information collection and processing, and traffic information pushing; proposes to use a Bluetooth module or a WIFI module in the dual-frequency pass card and the OBU to wirelessly connect with an in-vehicle multimedia terminal, so as to provide traffic information of the road ahead, and collect vehicle running state information; and proposes to use vehicle exit and entry data collected by the 5.8 G route identification station and toll road exit and entry toll lane systems and data of the 5.8 G route identification station passing by to implement a complete information collection and prediction of the toll road; and in the meanwhile, the 5.8 G route identification station acts as a cloud, and can process vehicle information obtained by an upstream toll station and the 5.8 G route identification station at all times, and timely process and release information in a local scope.

In order to achieve the above objects, the technical solutions adopted by the present invention are as follows.

A toll road network traffic information collection and guidance system based on a route identification system comprises toll road exit and entry toll lane systems, a networked toll center system, a 5.8 G route identification station, a 5.8 G route identification station monitoring system, a dual-frequency pass card for MTC vehicles, an OBU and a non-cash payment card for ETC vehicles, an in-vehicle multimedia terminal and a traffic information processing system, wherein the vehicle passes by the 5.8 G route identification station in a free-flow state, and the 5.8 G route identification station is configured to conduct a two-way wireless communication with the dual-frequency pass card or the OBU in the vehicle through a 5.8 GHz frequency band to receive information in the dual-frequency pass card or the OBU, and store, count, estimate and predict such information, and launch identification information and traffic information; the dual-frequency pass card or the OBU is configured to receive and store information launched by the 5.8 G route identification station, and wirelessly transfer the traffic information to the in-vehicle multimedia terminal through a built-in wireless transmission module; and the traffic information processing system is configured to integrate information collected and processed by the 5.8 G route identification station in real-time through the 5.8 G route identification station monitoring system with exit and entry information collected and processed by the toll road exit and entry toll lane systems in real-time through the networked toll center system, count, estimate and predict the information in combination with historical data, then wirelessly transmit the traffic information estimated and predicted by the traffic information processing system or the 5.8 G route identification station to an in-vehicle multimedia terminal in a vehicle at a demanded location.

Preferably, the dual-frequency pass card is a pass card that integrates a 13.56 MHz non-contact IC card and a 5.8 GHz RFID card into a whole by a card internal circuit, and the dual-frequency pass card internally comprises an MCU, a power module, a storage unit module, a 5.8 G transceiver, a Mifare-one card, a Bluetooth module, and a wake-up circuit module, and the MCU is separately connected to each of the other modules for controlling a normal operation of each module; the power module is configured to provide power for the MCU, the 5.8 G transceiver, the storage unit module, the wake-up circuit module and the Bluetooth module; the dual-frequency pass card receives and transmits information during a wake-up time, and the wake-up circuit module wakes up for a certain period of time after receiving a signal of a 13.56 MHz or 5.8 GHz frequency band, and completes reading and writing entry and exit information and route information; at the toll road entry toll lane system, the Mifare-one card in the dual-frequency pass card and a Mifare reader-writer implement a two-way communication to write the entry information; on the way, the 5.8 G transceiver of the dual-frequency pass card can receive identification station information comprising an ID number, a driving direction and timestamp information of the identification station sent by the 5.8 G route identification station, and write the information into the Mifare-one card and the storage unit module under a coordination of the MCU, and transmits the entry information in the storage unit module and information of the 5.8 G route identification station passing by to the 5.8 G route identification station; at the toll road exit toll lane system, the entry information in the dual-frequency pass card and the information of the 5.8 G route identification station passing by are read out through the Mifare reader-writer; and the dual-frequency pass card can be wirelessly connected to the in-vehicle multimedia terminal through an internal Bluetooth module or WIFI module of the dual-frequency pass card.

Preferably, a 5.8 G transceiver of the dual-frequency pass card and a 5.8 G transceiver of the OBU are configured to receive ahead traffic information sent by the 5.8 G route identification station, and a Bluetooth module or a WIFI module in the dual-frequency pass card and a Bluetooth module or a WIFI module in the OBU are wirelessly connected to the in-vehicle multimedia terminal, to provide real-time traffic state and service facility guidance information ahead the vehicle through a voice and/or a real-time traffic state graph; the in-vehicle multimedia terminal comprises a smartphone, a smart earphone, a smart bracelet and an on-board multimedia terminal; the on-board multimedia terminal can be connected to an on-board diagnosis computer, and can collect vehicle driving state information; and the dual-frequency pass card and the OBU can receive vehicle running state information collected by the on-board multimedia terminal through the Bluetooth module or the WIFI module.

Preferably, the information in the dual-frequency pass card or the OBU received by the 5.8 G route identification station comprises an ID number of the dual-frequency pass card or the OBU, an entry location and time, a vehicle model and a weight, and an ID number, a driving direction and timestamp information of the 5.8 G route identification station passing by; the entry information further comprises a license plate number, vehicle color information and a number of vehicle axle wheels in the dual-frequency pass card, a license plate number, a license plate color, a vehicle user type, a vehicle size, a number of axles, a number of wheels, a wheelbase, and a vehicle load/number of seats, vehicle characterization and vehicle engine number information in the OBU; and the information in the dual-frequency pass card or the OBU received by the 5.8 G route identification station further comprises vehicle running state information comprising a vehicle engine number, exhaust emissions, a vehicle velocity, an accelerated velocity, a steering angle, and steering and braking information.

Preferably, the 5.8 G route identification station is at least disposed on a road section of an unsupported tree structure in a connected graph of a toll road. At the toll road exit toll lane system, the MTC vehicle obtains the information of the 5.8 G route identification station passing by through the dual-frequency pass card to implement a real route identification of the vehicle, and the ETC vehicle obtains the information of the 5.8 G route identification station passing by through the on-board OBU to implement the real route identification of the vehicle.

Preferably, the 5.8 G route identification station is disposed in an accident blackspot, ahead an important exit ramp, in a special road section, or in every one to four kilometers of a road section according to real-time requirements on traffic information collection.

Preferably, the 5.8 G route identification station is served as virtual non-stop exit and entry toll lane systems, when the vehicle enters an identification location of the 5.8 G route identification station, the 5.8 G route identification station is served as the virtual non-stop exit toll lane system, and when the vehicle leaves the identification location of 5.8 G route identification station, the 5.8 G route identification station is served as the virtual non-stop entry toll lane system; the toll road exit and entry toll lane systems and the virtual non-stop exit and entry toll lane systems are served as a cloud for information collection and processing, and are configured to utilize the information in the dual-frequency pass card or the OBU or the non-cash payment card at the time of collection, and stored historical data to directly estimate and predict a travel time of passengers and cargos by vehicle models, and a flow of passengers and cargos by vehicle models from the entry to the exit, from the entry to the 5.8 G route identification station, from the 5.8 G route identification station to the 5.8 G route identification station, and from the 5.8 G route identification station to the exit of the toll road network, collected by the cloud in the time period; and the traffic information processing system is served as a cloud center for integrating vehicle data of the same road section in the same time period according to processing results of each cloud, and estimating a traffic flow, a velocity, a traffic density, a traffic state and a travel time of passengers and cargos by vehicle models of each section in the toll road network, and predicting an OD traffic, a travel time, and a traffic condition of passengers and cargos by vehicle models in the entire network.

Preferably, estimating the travel time is to divide the toll road section into a basic road section by adjacent toll stations, if the 5.8 G route identification station exists in a certain road section, then the road section is subdivided by the 5.8 G route identification station, which is specifically divided as follows: from an upstream toll station to the 5.8 G route identification station, and from the 5.8 G route identification station to a downstream toll station, using exit and entry time difference information in the dual-frequency pass card or the OBU or the non-cash payment card collected in real-time by the toll road exit and entry toll lane systems and the 5.8 G route identification station to remove disturbance data, obtain all the travel time by vehicle types from the entry to the exit, from the entry to the 5.8 G route identification station, from the 5.8 G route identification station to the 5.8 G route identification station, and from the 5.8 G route identification station to the exit of the toll road in different time intervals, and then perform weighted stacking calculation on the travel time by vehicle models of different exits and entries according to a principle that the travel time is more accurate when a distance between ODs on a line is longer and according to a method that a weight is larger when a distance between the road sections is longer, and stack the travel time of all the road sections in the entire toll road to accurately estimate the travel time by vehicle models between all the ODs in the toll road network; in the meanwhile, the cloud center uses regression analysis to study a correlation between the vehicle travel time and vehicle models, and between a toll road section location and a time period (such as the same time period of a certain month, the same time period of a certain week, and the same time period of a certain day) variable according to massive historical data and real-time travel time estimation, and then determines an impact factor of the variable to the travel time according to a correlation coefficient of the variable and the travel time, and implements prediction of vehicle travel time in a short time at next moment of the toll road through calculating the impact factor and the historical travel time; estimating the traffic flow of the road section is to first estimate a mean driving trajectory of the vehicle, and then convert different vehicle models into standard models based on different road possession degrees of different vehicle models, and use the calculated basic road travel time to linearize velocities of the vehicle on different road sections, wherein an initial velocity is a tail end velocity of a last vehicle driving section, and a terminal velocity is an initial velocity of a next road section, location information of the vehicle at any time can be obtained by calculating the driving trajectory of the vehicle, thereby obtaining a number of existing vehicles on any road section on the road, a number of vehicles in the virtual non-stop exit toll lane system and an exit ramp drive-off road section in the road sections, a number of vehicles in the upstream virtual non-stop entry toll lane system and an entry ramp entering road section in the road sections, so that a traffic flow of any road section can be obtained according to the number of vehicles passing by the same section in the same time interval; the velocity is calculated according to all the distances from the entry to the exit, the entry to the 5.8 G route identification station, the 5.8 G route identification station to the 5.8 G route identification station, and the 5.8 G route identification station to the exit of the toll road, and the travel time needed for the vehicle to pass through the distance; and the traffic state is obtained by evaluating and analyzing the travel time and velocity of the road section obtained in real-time on the toll road network and road section saturation obtained by estimating the traffic flow of the road section and a traffic capacity analysis of the road section, thereby obtaining real-time dynamic traffic state information.

Preferably, the 5.8 G route identification station is disposed at an entry and an exit of a toll road service area to count and analyze a flow of passengers and cargos by vehicle models and a vehicle stay rule in the service area through the information in the dual-frequency pass card or the OBU obtained by the 5.8 G route identification station, and predict the flow of passengers and cargos by vehicle models and an operating income in the service area.

Preferably, the 5.8 G route identification station is also provided with a high-definition license plate identification system which matches a vehicle license plate number and a license plate color captured with the vehicle information in the dual-frequency pass card or the OBU obtained by the 5.8 G route identification station to judge whether there is a dual-frequency pass card or an OBU in the vehicle, how many dual-frequency pass card in the vehicle, and whether the vehicle information is matched with the information of the vehicle captured, and is applied to a toll road anti-escape system.

Compared with the existing toll road information collection technologies, the present invention has the following beneficial effects.

1. In the present invention, the dual-frequency pass card and the OBU are adopted to implement the accurate route identification of the vehicle, and the functions of toll road networked toll as well as traffic information collection and guidance can be implemented by only mounting a certain amount of 5.8 G route identification stations on the toll road section according to the route identification demands and the traffic information collection requirements, which does not need to separately construct a traffic flow investigation station and vehicle detectors, and is simple to maintain, greatly saves the information collection cost of the toll road, and will replace the traditional vehicle detector and other information collection methods.

2. According to the present invention, the collection of complete information such as the vehicle entry information (the entry location and time, the license plate number, the license plate color, the vehicle user type, the vehicle size, the number of axles, the number of wheels, the wheelbase, the vehicle load/number of seats, the vehicle characterization and the vehicle engine number), the information of the 5.8 G route identification station (the ID number, the driving direction and the timestamp) passing by, the running information of the vehicle passing by (the velocity, the accelerated velocity, the steering angle, the exhaust emissions, and the steering and braking information), etc., is implemented through the ambiguous route identification system.

3. As the cloud for information collection and processing, the 5.8 G route identification station in the present invention can quickly process the vehicle information obtained by the upstream toll station and the 5.8 G route identification station, conduct the information processing and analysis in local range, and transfer the information to the road users in real-time according to the needs. The distributed calculation of information is implemented through the cloud, which avoids errors during complete uploading of the information caused by oversize road network data; meanwhile, the toll road route information is timely updated according to the real-time vehicle information, so as to provide timely and reliable data support for automatic driving, traffic monitoring and travelers.

4. In the present invention, the Bluetooth module in the dual-frequency pass card and the Bluetooth module in the OBU can be connected to the in-vehicle multimedia terminal, to play the guidance information such as the ahead travel time and traffic state obtained by the cloud center or cloud in real-time by voice/image. The real-time voice and/or image reminding is different from extensive indiscriminate playing performed by broadcasting. The broadcasted information is useless for most drivers, while the voice/image of the present invention only transfers the information ahead the driver, so that the information is highly effective, and the human-machine experience function is good.

5. In the present invention, the 5.8 GHz frequency band conforming to the national highway electronic toll standard is used to implement the two-way communication between the 5.8 G route identification station and the OBU for ETC vehicles and the dual-frequency pass card for MTC vehicles, and the route identification, traffic information collection and processing, and traffic information pushing are completed.

6. In the present invention, the 5.8 G route identification station is set based on a graph-theoretical algorithm to reduce unnecessary identification station facilities, and the information collection and processing system has the advantages of low cost, good reliability and high accuracy. The identification station can also be set in the accident blackspot, ahead the important exit ramp and in the special road section, such as the entry and exit of the toll road service area, to count and analyze the flow of passengers and cargos by vehicle models and the vehicle stay rule in the service area, and predict the flow of passengers and cargos by vehicle models and the operating income in the service area.

7. The dual-frequency pass card of the present invention is compatible with the existing toll system, and can read and write the information in the dual-frequency pass card without replacing the reader-writer, which reduces the cost on updating lane software and implements the smooth transition of the toll system.

8. The traffic information collected by the present invention provides comprehensive and reliable data information for the toll management of the toll road, the anti-escape by vehicle inspection, the traffic investigation, the road maintenance and repair, and the overload management of the toll road.

It is particularly proposed that China has implemented nationwide non-stop networked toll collection, and the non-stop networked toll collection will also be used on residential access control and parking lot toll collection in larger scale. There will be a large number of vehicles installed with an OBU on non-toll roads, so the present invention can also be used in the traffic information collection and guidance of urban, provincial and national roads.

### BRIEF DESCRIPTION OF THE DRAWINGS

FIG. 1 is a block diagram of a system according to the present invention.

FIG. 2 is a schematic diagram of traffic information collection and processing according to the present invention.

FIG. 3 is a structural schematic diagram of a dual-frequency pass card according to the present invention.

FIG. 4 is a schematic diagram showing a difference between calculation of a travel time according to the present invention and a conventional method.

FIG. 5 is a schematic diagram showing a definition of a road section for calculating a travel time of a road section according to the present invention.

FIG. 6 is a space-time grid chart for calculating a travel time of a road section according to the present invention.

FIG. 7 is a virtual driving trajectory of a vehicle in a space-time grid for calculating a travel time of a road section according to the present invention.

FIG. 8 is a schematic diagram of a road section flow in traffic statistics according to the present invention.

FIG. 9 is a schematic diagram of a traffic flow entering from a node k−i and passing by other nodes in each time interval in traffic statistics according to the present invention.

FIG. 10 is a sample graph of a travel velocity calculation model according to the present invention.

### DETAILED DESCRIPTION OF THE PREFERRED EMBODIMENT

The present invention will be further described below in combination with embodiments and accompanying drawings, but specific implementation of the present invention are not limited hereto.

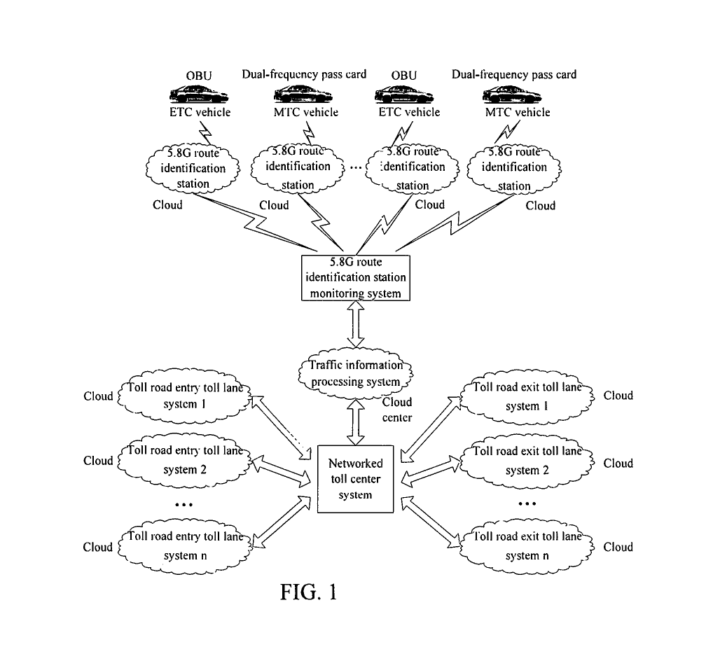

As shown in FIG. 1, a toll road network traffic information collection and guidance system based on a route identification system comprises toll road exit and entry toll lane systems, a networked toll center system, a 5.8 G route identification station, a 5.8 G route identification station monitoring system, a dual-frequency pass card for MTC vehicles, an OBU and a non-cash payment card for ETC vehicles, an in-vehicle multimedia terminal and a traffic information processing system, wherein the vehicle passes by the 5.8 G route identification station in a free-flow state, and the 5.8 G route identification station is configured to conduct a two-way wireless communication with the dual-frequency pass card or the OBU in the vehicle through a 5.8 GHz frequency band to receive information in the dual-frequency pass card or the OBU, and store, count, estimate and predict such information, and launch identification information and traffic information; the dual-frequency pass card or the OBU is configured to receive and store information launched by the 5.8 G route identification station, and wirelessly transfer the traffic information to the in-vehicle multimedia terminal through a built-in wireless transmission module; and the traffic information processing system is configured to integrate information collected and processed by the 5.8 G route identification station in real-time through the 5.8 G route identification station monitoring system with exit and entry information collected and processed by the toll road exit and entry toll lane systems in real-time through the networked toll center system, count, estimate and predict the information in combination with historical data, then wirelessly transmit the traffic information estimated and predicted by the traffic information processing system or the 5.8 G route identification station to an in-vehicle multimedia terminal in a vehicle at a demanded location. The traffic information processing system is intended to use ambiguous route identification systems of the toll road for ETC vehicles and MTC vehicles to conduct toll road traffic information collection and guidance.

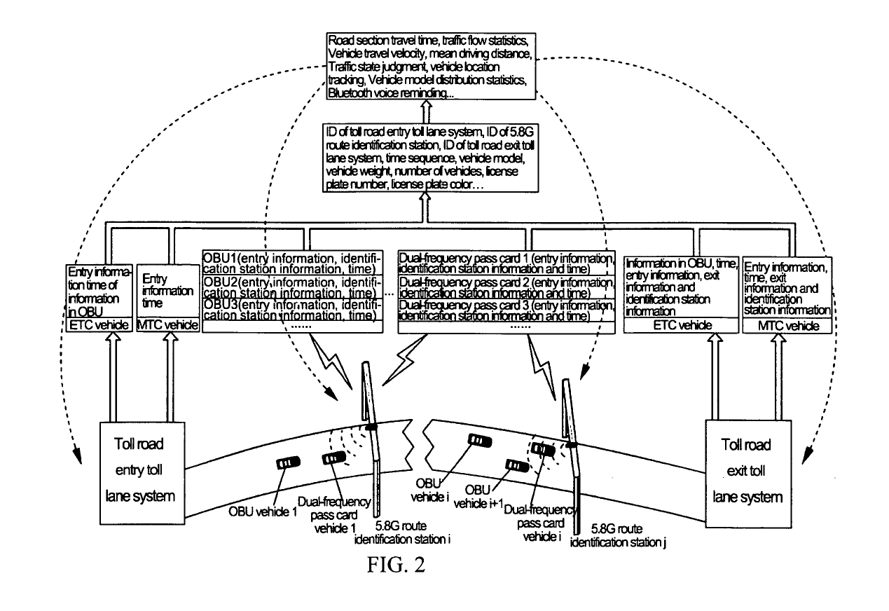

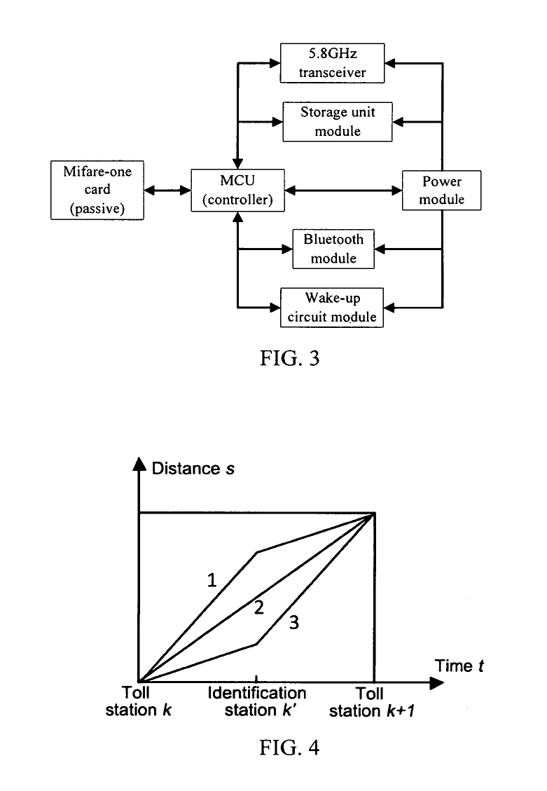

A real restoration of ETC vehicle route and MTC vehicle route of the toll road is realized through the toll road entry and exit toll lane systems, the OBU, the dual-frequency pass card and the 5.8 G route identification station, and meanwhile, the vehicle traffic information can be collected in real-time through the ambiguous route system. As shown in FIG. 2, data processing is conducted through the traffic information processing system to obtain the required traffic information, and dynamic traffic information is obtained by timely updating according to real-time data.

The dual-frequency pass card is a pass card that integrates a 13.56 MHz non-contact IC card and a 5.8 GHz RFID card into a whole by a card internal circuit, and the dual-frequency pass card internally comprises an MCU, a power module, a storage unit module, a 5.8 G transceiver, a Mifare-one card, a Bluetooth module, and a wake-up circuit module, and the MCU is separately connected to each of the other modules for controlling a normal operation of each module; the power module is configured to provide power for the MCU, the 5.8 G transceiver, the storage unit module, the wake-up circuit module and the Bluetooth module; the dual-frequency pass card receives and transmits information during a wake-up time, and the wake-up circuit module wakes up for a certain period of time after receiving a signal of a 13.56 MHz or 5.8 GHz frequency band, and completes reading and writing entry and exit information and route information; at the toll road entry toll lane system, the Mifare-one card in the dual-frequency pass card and a Mifare reader-writer implement a two-way communication to write the entry information; on the way, the 5.8 G transceiver of the dual-frequency pass card can receive identification station information comprising an ID number, a driving direction and timestamp information of the identification station sent by the 5.8 G route identification station, and write the information into the Mifare-one card and the storage unit module under a coordination of the MCU, and transmits the entry information in the storage unit module and information of the 5.8 G route identification station passing by to the 5.8 G route identification station; at the toll road exit toll lane system, the entry information in the dual-frequency pass card and the information of the 5.8 G route identification station passing by are read out through the Mifare reader-writer to implement vehicle route identification; and the dual-frequency pass card can be wirelessly connected to the in-vehicle multimedia terminal through an internal Bluetooth module of the dual-frequency pass card.

The information in the dual-frequency pass card or the OBU received by the 5.8 G route identification station comprises an ID number of the dual-frequency pass card or the OBU, an entry location and time, a vehicle model and a weight, and an ID number, a driving direction and timestamp information of the 5.8 G route identification station passing by; the entry information further comprises a license plate number, vehicle color information and a number of vehicle axle wheels in the dual-frequency pass card, a license plate number, a license plate color, a vehicle user type, a vehicle size, a number of axles, a number of wheels, a wheelbase, and a vehicle load/number of seats, vehicle characterization and vehicle engine number information in the OBU.

A 5.8 G transceiver of the dual-frequency pass card and a 5.8 G transceiver of the OBU are configured to receive ahead traffic information sent by the 5.8 G route identification station, and a Bluetooth module in the dual-frequency pass card and a Bluetooth module in the OBU is wirelessly connected to the in-vehicle multimedia terminal, to provide real-time traffic state and service facility guidance information ahead the vehicle through a voice; the 5.8 G transceiver of the dual-frequency pass card and the 5.8 G transceiver of the OBU are further configured to receive a real-time traffic state graph of the toll road network transmitted by the 5.8 G route identification station. The in-vehicle multimedia terminal comprises a smartphone, a smart earphone, a smart bracelet and an on-board multimedia terminal.

The on-board multimedia terminal can be connected to an on-board diagnosis computer, and collects vehicle driving state information such as a vehicle engine number, exhaust emissions, a vehicle velocity, an accelerated velocity, a steering angle, steering and braking information, a mileage, a driving time, and other information in real-time through the on-board diagnosis computer (OBD). When the vehicle passes the 5.8 G route identification station, through a wireless link among the on-board multimedia terminal, the dual-frequency pass card or OBU, and the 5.8 G route identification station, the 5.8 G route identification station can collect the running state information of each vehicle passing by according to the needs, so as to provide accurate data support for autonomous driving and traffic control.

In one embodiment of the present invention, the 5.8 G route identification station is at least disposed on a road section of an unsupported tree structure in a connected graph of a toll road, at the toll road exit toll lane system, the MTC vehicle obtains the information of the 5.8 G route identification station passing by through the dual-frequency pass card to implement a real route identification of the vehicle, and the ETC vehicle obtains the information of the 5.8 G route identification station passing by through the on-board OBU to implement the real route identification of the vehicle.

In one embodiment of the present invention, the 5.8 G route identification station is disposed in an accident blackspot, ahead an important exit ramp, in a special road section, or in every one to four kilometers of a road section according to real-time requirements on traffic information collection.

In one embodiment of the present invention, the 5.8 G route identification station is served as virtual non-stop exit and entry toll lane systems, when the vehicle enters an identification location of the 5.8 G route identification station, the 5.8 G route identification station is served as the virtual non-stop exit toll lane system, and when the vehicle leaves the identification location of 5.8 G route identification station, the 5.8 G route identification station is served as the virtual non-stop entry toll lane system; the toll road exit and entry toll lane systems and the virtual non-stop exit and entry toll lane systems are served as a cloud for information collection and processing, and are configured to utilize the information in the dual-frequency pass card or the OBU or the non-cash payment card at the time of collection, and stored historical data to directly estimate and predict passenger and cargo travel time by vehicle types and passenger and cargo flow by vehicle types from the entry to the exit, from the entry to the 5.8 G route identification station, from the 5.8 G route identification station to the 5.8 G route identification station, and from the 5.8 G route identification station to the exit of the toll road network, collected by the cloud in the time period; and the traffic information processing system is served as a cloud center for integrating vehicle data of the same road section in the same time period according to processing results of each cloud, and estimating a traffic flow, a velocity, a traffic density, a traffic state and a travel time of passengers and cargos by vehicle models of each section in the toll road network, and predicting an OD traffic, a travel time, and a traffic condition of passengers and cargos by vehicle models in the entire network.

Specifically, estimating the travel time is to divide the toll road section into a basic road section by adjacent toll stations, if the 5.8 G route identification station exists in a certain road section, then the road section is subdivided by the 5.8 G route identification station, which is specifically divided as follows: from an upstream toll station to the 5.8 G route identification station, and from the 5.8 G route identification station to a downstream toll station, using exit and entry time difference information in the dual-frequency pass card or the OBU or the non-cash payment card collected in real-time by the toll road exit and entry toll lane systems and the 5.8 G route identification station to remove disturbance data, obtain all the travel time by vehicle types from the entry to the exit, from the entry to the 5.8 G route identification station, from the 5.8 G route identification station to the 5.8 G route identification station, and from the 5.8 G route identification station to the exit of the toll road in different time intervals, and then perform weighted stacking calculation on the travel time by vehicle models of different exits and entries according to a principle that the travel time is more accurate when a distance between ODs on a line is longer and according to a method that a weight is larger when a distance between the road sections is longer, and stack the travel time of all the road sections in the entire toll road to accurately estimate the travel time by vehicle models between all the ODs in the toll road network; in the meanwhile, the cloud center uses regression analysis to study a correlation between the vehicle travel time and vehicle models, and between a toll road section location and a time period (such as the same time period of a certain month, the same time period of a certain week, and the same time period of a certain day) variable according to massive historical data and real-time travel time estimation, and then determines an impact factor of the variable to the travel time according to a correlation coefficient of the variable and the travel time, and implements prediction of vehicle travel time in a short time at next moment of the toll road through calculating the impact factor and the historical travel time; estimating the traffic flow of the road section is to first estimate a mean driving trajectory of the vehicle, and then convert different vehicle models into standard models based on different road possession degrees of different vehicle models, and use the calculated basic road travel time to linearize velocities of the vehicle on different road sections, wherein an initial velocity is a tail end velocity of last vehicle driving section, and a terminal velocity is an initial velocity of next road section, the location information of the vehicle at any time can be obtained by calculating the driving trajectory of the vehicle, thereby obtaining a number of existing vehicles on any road section on the road, a number of vehicles in the virtual non-stop exit toll lane system and an exit ramp drive-off road section in the road sections, a number of vehicles in the upstream virtual non-stop entry toll lane system and an entry ramp entering road section in the road sections, so that a traffic flow of any road section can be obtained according to the number of vehicles passing by the same section in the same time interval; the velocity is calculated according to all the distances from the entry to the exit, the entry to the 5.8 G route identification station, the 5.8 G route identification station to the 5.8 G route identification station, and the 5.8 G route identification station to the exit of the toll road, and the travel time needed for the vehicle to pass through the distance; and the traffic state is obtained by evaluating and analyzing the travel time and velocity of the road section obtained in real-time on the toll road network and road section saturation obtained by estimating the traffic flow of the road section and a traffic capacity analysis of the road section, thereby obtaining real-time dynamic traffic state information.

In one embodiment of the present invention, the 5.8 G route identification station is disposed at an entry and an exit of a toll road service area to count and analyze a flow of passengers and cargos by vehicle models and a vehicle stay rule in the service area through the information in the dual-frequency pass card or the OBU obtained by the 5.8 G route identification station, and predict the flow of passengers and cargos by vehicle models and an operating income in the service area.

In one embodiment of the present invention, the 5.8 G route identification station is also provided with a high-definition license plate identification system which matches a vehicle license plate number and a license plate color captured with the vehicle information in the dual-frequency pass card or the OBU obtained by the 5.8 G route identification station to judge whether there is a dual-frequency pass card or an OBU in the vehicle, how many dual-frequency pass card in the vehicle, and whether the vehicle information is matched with the information of the vehicle captured, and is applied to a toll road anti-escape system.

The running processes of the MTC vehicle and the ETC vehicle in the system are as follows:

When the MTC vehicle enters the toll road entry lane system, the dual-frequency pass card and the toll road entry toll lane system conduct a two-way authentication, and the entry and exit information and the route information in the dual-frequency pass card are automatically cleared, in the meanwhile, the entry information (entry location and time, vehicle model and weight) and the ahead traffic information of the toll station are written into the dual-frequency pass card through the Mifare reader-writer; when the vehicle runs on the toll road in a free-flow state and passes by the 5.8 G route identification station, the dual-frequency pass card conducts a two-way authentication with the 5.8 G route identification station, and the dual-frequency pass card receives information (ID number, driving direction and timestamp) of the 5.8 G route identification station and ahead traffic information of the identification station, and stores the information in the dual-frequency pass card; meanwhile, the dual-frequency pass card uploads the entry information (entry location and time, vehicle model and weight, license plate number, and vehicle color) therein and information (ID number, driving direction and timestamp) of the identification station passing by in last road section to the 5.8 G route identification station. As a cloud for information collection and processing, the 5.8 G route identification station can directly estimate and predict the travel time of passengers and cargos by vehicle models, and the flow of passengers and cargos by vehicle models from the entry to the exit, from the entry to the 5.8 G route identification station, from the 5.8 G route identification station to the 5.8 G route identification station, and from the 5.8 G route identification station to the exit of the toll road network, collected by the cloud in the time period, and transfer the collected and processed information to the traffic information processing system through the networked toll center system. Meanwhile, the 5.8 G route identification station transmits the ahead traffic information of the road according to the cloud center and/or the cloud to the dual-frequency pass card, and the dual-frequency pass card is wirelessly connected to the in-vehicle multimedia terminal through the Bluetooth module, to broadcast the traffic information to road users in real-time. The in-vehicle multimedia terminal may be a smartphone, a smart earphone, a smart bracelet and an on-board multimedia terminal; when the vehicle enters the toll road exit toll lane system, the dual-frequency pass card conducts two-way authentication with the exit lane system, the entry information (entry location and time, vehicle model and weight, license plate number, and vehicle color) of the dual-frequency pass card and the information (ID number, driving direction and timestamp) of the identification station passing by are read out through the Mifare reader-writer, and the vehicle models and the weight information at the exit are collected, then toll collection is conducted according to an actual route length, a vehicle model and a weight (a freight car is collected by the weight, while a passenger car is collected by the vehicle model), and then the entry information of the dual-frequency pass card and the information of the identification station passing by are cleared. Meanwhile, as a cloud for information processing, the toll road exit toll lane system can directly estimate and predict the travel time of passengers and cargos by vehicle models, and the flow of passengers and cargos by vehicle models from the entry to the exit, from the entry to the 5.8 G route identification station, from the 5.8 G route identification station to the 5.8 G route identification station, and from the 5.8 G route identification station to the exit of the toll road network, collected by the cloud in the time period, and transfer the collected and processed information to the traffic information processing system for integrating and processing through the networked toll center system.

When the ETC vehicle enters the toll road entry lane system, the OBU conducts a two-way authentication with the toll road entry toll lane system, and the entry and exit information and the route information in the OBU and non-cash payment card are automatically cleared, in the meanwhile, the entry information (entry location and time, vehicle model and weight) and the ahead traffic information of the toll station are written into the OBU through a 5.8 G antenna; when the vehicle runs on the toll road in a free-flow state and passes by the 5.8 G route identification station, the OBU conducts a two-way authentication with the 5.8 G route identification station, and the OBU receives information (ID number, driving direction and timestamp) of the 5.8 G route identification station and ahead traffic information of the identification station, and stores the information in the OBU and non-cash payment card; meanwhile, the OBU uploads the entry information (entry location and time, vehicle model and weight, license plate number, vehicle color, vehicle user type, vehicle size, number of axles, number of wheels, wheelbase, a vehicle load/number of seats, vehicle characterization and vehicle engine number) therein and information (ID number, driving direction and timestamp) of the identification station passing by in last road section to the current 5.8 G route identification station. As a cloud for information collection and processing, the 5.8 G route identification station can directly estimate and predict the travel time of passengers and cargos by vehicle models, and the flow of passengers and cargos by vehicle models from the entry to the exit, from the entry to the 5.8 G route identification station, from the 5.8 G route identification station to the 5.8 G route identification station, and from the 5.8 G route identification station to the exit of the toll road network, collected by the cloud in the time period, and transfer the collected and processed information to the traffic information processing system through the networked toll center system. Meanwhile, the 5.8 G route identification station transmits the ahead traffic information of the road according to the cloud center and/or the cloud to the OBU, and the OBU is wirelessly connected to the in-vehicle multimedia terminal through the Bluetooth module, to broadcast the traffic information to road users in real-time. The in-vehicle multimedia terminal may be a smartphone, a smart earphone, a smart bracelet and an on-board multimedia terminal; when the vehicle enters the toll road exit toll lane system, the OBU conducts two-way authentication with the toll road exit toll lane system, the entry information (entry location and time, vehicle model and weight) of the OBU and the information (ID number, driving direction and timestamp) of the identification station passing by are read out through a 5.8 G antenna, and the vehicle models and the weight at the exit are collected, then toll collection is conducted according to an actual route length, a vehicle model and a weight (a freight car is collected by the weight, while a passenger car is collected by the vehicle model), and then the entry information of the OBU and the information of the identification station passing by are cleared. Meanwhile, as a cloud for information processing, the exit toll lane system can directly estimate and predict the travel time of passengers and cargos by vehicle models, and the flow of passengers and cargos by vehicle models from the entry to the exit, from the entry to the 5.8 G route identification station, from the 5.8 G route identification station to the 5.8 G route identification station, and from the 5.8 G route identification station to the exit of the toll road network, collected by the cloud in the time period, and transfer the collected and processed information to the traffic information processing system for integrating and processing through the networked toll center system.

For a vehicle mounted with an OBU, when the vehicle enters the toll road exit toll lane system without a 5.8 G antenna, the non-cash payment card conducts a two-way authentication with the toll road toll lane system, the entry information (entry location and time, vehicle model and weight, license plate number, and vehicle color) of the non-cash payment card and the information (ID number, driving direction and timestamp) of the identification station passing by are read out directly through the Mifare reader-writer, and the vehicle models and the weight information at the exit are collected, then toll collection is conducted according to an actual route length, a vehicle model and a weight (a freight car is collected by the weight, while a passenger car is collected by the vehicle model), and then the entry information of the OBU and the information of the identification station passing by are cleared. Meanwhile, as a cloud for information processing, the toll road exit toll lane system can directly estimate and predict the travel time of passengers and cargos by vehicle models, and the flow of passengers and cargos by vehicle models from the entry to the exit, from the entry to the 5.8 G route identification station, from the 5.8 G route identification station to the 5.8 G route identification station, and from the 5.8 G route identification station to the exit of the toll road network, collected by the cloud in the time period, and transfer the collected and processed information to the traffic information processing system for integrating and processing through the networked toll center system.

The processing and application of the traffic information data in the present invention are specifically as follows:

(1) Travel Time Calculation

The travel time recorded by the system not only includes the travel time of the road section, but also includes other delays (such as delays at the toll station). In addition, due to some uncertain factors (such as: stopovers, particularly fast or particularly slow driving velocities, etc.), there is a very big difference between the travel time of a small number of vehicles and other vehicles in the vehicles departing from the same time interval in the record of the toll system. Therefore, it is necessary to preprocess the data and use probability statistics to remove noises.

As shown in FIG. 4, if there is no identification station k′ on a road section from a toll station k to a toll station k+1, a relation between the distance and the time will be considered as a straight line 2, but the actual situation may show the situations of a curve 1 and a curve 3. There is an obvious difference in the velocity changes in the road section. Shortening the road section by the identification stations can effectively reduce the calculation errors.

According to previous studies, the travel time of vehicles departing from the same time interval obeys a normal distribution. Based on this, the statistics of the travel time are defined as follows.

It is set that a mean travel time τ̅_{i,j}^{(p)} of vehicles departing from a time interval p and running between an entry and exit pair i, j is as shown in a formula below:

$${\overline{τ}}_{i , j}^{( p )} = \frac{1}{N} {\sum }_{n = 1}^{N} {τ}_{i , j , n}^{( p )} . \qquad ( 1 )$$

In the formula, N denotes a number of vehicles departing in the time interval p, i is an entry node, and j is an exit node.

A standard deviation of the travel time is:

$$S = \sqrt{\frac{{\sum }_{n = 1}^{N} {( {\overline{τ}}_{i , j}^{( p )} - {τ}_{i , j , n}^{( p )} )}^{2}}{N - 1}} . \qquad ( 2 )$$

τ̅_{i,j}^{(p)}±2S denotes a range of double standard deviations of a sample mean, and the probability of this range is 95.4% when obeying the normal distribution. The range of double standard deviations is used here to determine if the data is abnormal. The present invention proposes a following data filtering algorithm to filter data:

1) extracting a lower travel time threshold: an expressway generally has a velocity limit of 120 km/h; assuming that the maximum velocity is 115% of the velocity limit, then the minimum travel time=distance/maximum velocity, and the minimum travel time is a lower data threshold. When the travel time in the data is less than the threshold, it is determined as invalid data, and is eliminated from the sample;

2) recalculating a mean τ̅_{i,j}^{(p)} and a variance S of the remaining data in the sample;

3) determining whether there is data without the range of [τ̅_{i,j}^{(p)}−2S, τ̅_{i,j}^{(p)}+2S] in the sample, if yes, then eliminating the data without the range, going to 2) for recalculating until all the abnormal data is eliminated; and

4) calculating a sample mean t_{i,j}^{(p)}=τ̅_{i,j}^{(p)} after final screening.

The mean travel time t_{i,j}^{(p)} after preprocessing can accurately reflect set characteristics of the travel time of the vehicles departing from the time interval p on the road section s_{i,j}.

The travel time of each basic road section can be effectively obtained using the method.

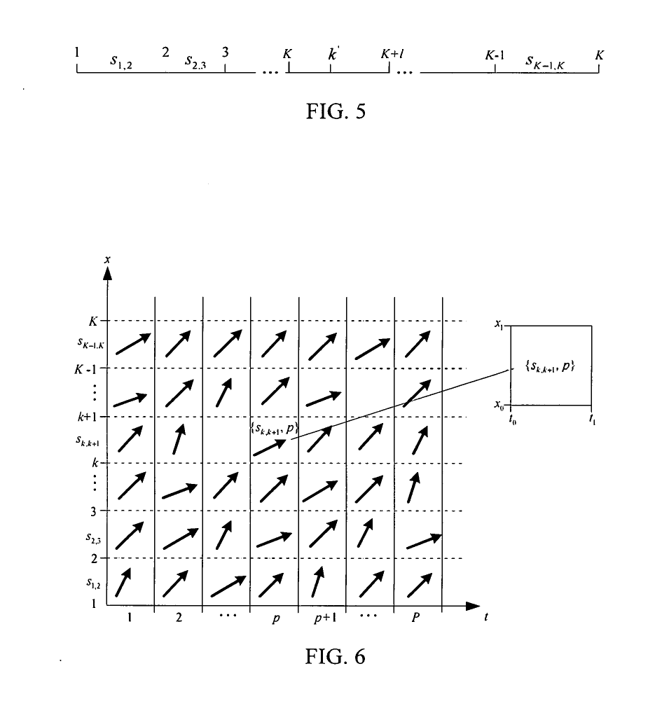

As shown in FIG. 5, k′ denotes the 5.8 G route identification station.

The longer the vehicle travels, the smaller the proportion of the delay time consumed by the exit and entry toll stations thereof to the travel time recorded during the whole course is, while the greater the proportion of the actual travel time of the vehicle on the road section is; therefore, the travel time recorded in the toll system is closer to the actual travel time of the vehicle on the road as the distance traveled by the vehicle increases.

The method of obtaining the travel time of any basic road section s_{k,k+1} based on preprocessing can be expressed by a “difference” of the travel time of two associated road sections. The difference between the travel time using different calculation methods is due to the difference in the distances traveled by the vehicle. Due to the deviation between “the travel time recorded by the system” and the “road section travel time”, it is necessary to obtain the “road section travel time” through a certain correction algorithm. Naturally, all the “travel time” used to represent the basic road section s_{k,k+1} can be assigned a weight that is consistent with a length of the road section corresponding to the travel time data, i.e., the longer the road section distance is, the greater the weight is, and a final “corrected road section travel time” is obtained by multiplying all the “travel time” by this weight and then adding up.

In particular, the travel time from the node k to the node k+1 is equal to the sum of the time from the node k to an identification station k′ and the time from the identification station k′ to the node k+1. The time from the node k to the identification station k′ is taken as a calculating example only for illustration hereunder.

A travel time algorithm from the node k to the node k+1 is as follows:

$$\begin{matrix}{t}_{k , {k}^{′}}^{{}^{′} ( p )} = \frac{{l}_{1 , {k}^{′}}}{{W}_{k , {k}^{′}}} ( {t}_{1 , {k}^{′}}^{( {r}_{1} )} - {t}_{1 , k}^{( {r}_{1} )} ) + … + \frac{{l}_{k - 1 , {k}^{′}}}{{W}_{k , {k}^{′}}} ( {t}_{k - 1 , {k}^{′}}^{( {r}_{k - 1} )} - {t}_{k - 1 , k}^{( {r}_{1} )} ) + \frac{{l}_{k , {k}^{′}}}{{W}_{k , {k}^{′}}} {t}_{k , {k}^{′}}^{( p )} + \frac{{l}_{{k}^{′} , k + 1}}{{W}_{k , {k}^{′}}} ( {t}_{k , k + 1}^{( p )} - {t}_{{k}^{′} , k + 1}^{( q )} ) + … + \frac{{l}_{k , K}}{{W}_{k , {k}^{′}}} ( {t}_{k , K}^{( p )} - {t}_{{k}^{′} , K}^{( q )} ) = {\sum }_{i = 1}^{k - 1} \frac{{l}_{i , {k}^{′}}}{{W}_{k , {k}^{′}}} ( {t}_{i , {k}^{′}}^{( {r}_{1} )} - {t}_{i , k}^{( {r}_{1} )} ) + \frac{{l}_{k , {k}^{′}}}{{W}_{k , {k}^{′}}} {t}_{k , {k}^{′}}^{( p )} + {\sum }_{j = k + 1}^{K} \frac{{l}_{k , j}}{{W}_{k , {k}^{′}}} ( {t}_{k , j}^{( p )} - {t}_{{k}^{′} , j}^{( q )} ) & ( 3 ) \\ {W}_{k , k + 1} = {l}_{1 , {k}^{′}} + {l}_{2 , {k}^{′}} + … + {l}_{k , {k}^{′}} + {l}_{k , k + 1} + {l}_{k , k + 2} + … + {l}_{k , K} = {\sum }_{i = 1}^{k} {l}_{i , {k}^{′}} + {\sum }_{j = k + 1}^{K} {l}_{k , j} . & ( 4 )\end{matrix}$$

In the formula (3), p is the time interval of vehicles departing from the current node k, rᵢ(i=1, 2, 3, . . . , k−1) is a departure time interval of vehicles departing from a node k−1 upstream the node k, p is just the time interval in which the vehicles departing from the upstream node k−1 to the node k from the time interval rᵢ are located, while q is the time interval in which the vehicles departing from the node k to a downstream node k+1 from the time interval p are located, and W_{k,k+1} is the sum of the running distances of the vehicles. Finally, the travel time from the adjacent nodes k to k′(k=1, 2, 3, . . . , K−1) is t′_{k,k′}^{(p)}; the travel time t′_{k,k′+1}^{(p)} from the nodes k′ to k+1 can be obtained using the same method; and in this way, it can be obtained that the travel time from the nodes k to k+1 is t′_{k,k′}^{(p)}+t′_{k,k′+1}^{(p)}.

The travel time estimation between any ODs can be accurately obtained through the above-mentioned method, so that the travel time between any ODs at any moment can be uploaded to a cloud center; in the meanwhile, the cloud center uses regression analysis to study a correlation between the vehicle travel time and vehicle models, and between a toll road section location and a time (such as the same time period of a certain month, the same time period of a certain week, and the same time period of a certain day) variable according to massive historical data and real-time travel time estimation, and then determines an impact factor of the variable to the travel time according to a correlation coefficient of the variable and the travel time, and implements a prediction of vehicle travel time in a short time at a next moment of the toll road through calculating the impact factor and the historical travel time.

(2) Traffic Flow Statistics

The traffic flow of the vehicle can be accurately obtained by estimating the vehicle trajectory. The entire expressway network can be further divided through identification stations and toll stations. It is assumed that the travel time between the basic road sections along the line is independent, and it is also assumed that vehicles of the same models travel at a constant velocity within the same small time interval p of the same road section s_{k,k+1}. In this way, the road section and the time can be abstracted into a space-time grid region composed of a space-time grid unit {s_{k,k+1},P} (k∈[1, 2, . . . , K], p∈[1, 2, . . . , P]), where s_{k,k+1} represents a basic road section, and p represents the time interval, as shown in FIG. 6. In each space-time grid unit {s_{k,k+1},p} the velocity v(s_{k,k+1},p) is constant. Therefore, the location and time of entering and leaving each space-time grid unit {s_{k,k+1},p} of the vehicle departing from any node k can be found, and the driving trajectory of the vehicle is to connect entry and exit points of all the space-time grid units that the vehicle passes by. Each space-time grid unit {s_{k,k+1},p} is deemed as a rectangular region, the boundaries of which are [t₀,t₁] on a time axis and [x₀,x₁] on a spatial axis. {x⁰,t⁰} denotes the location and time of the vehicle entering the current rectangular region, {x*,t*} denotes the location and time of the vehicle leaving the current rectangular region, and {x*, t*} is also an initial location and time of the vehicle entering next rectangular region. Therefore, the distance range of a certain road section s_{k,k+1} is [x₀,x₁], and the vehicle needs to pass through at least one space-time grid unit to cross the entire road section.

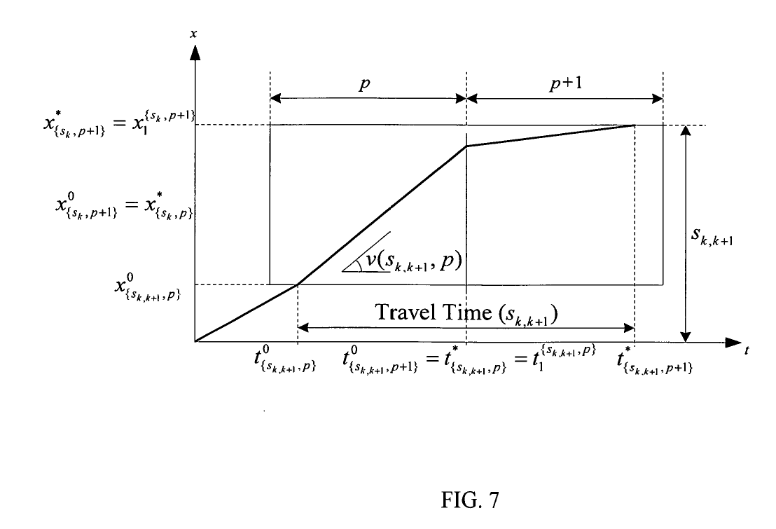

It can be seen from FIG. 7 that the nodes k to k+1 can be subdivided into [k,k′] and [k′,k+1] using the data of the identification station, and the velocity departing from the time interval p on the section [k,k′], and the velocity departing from the time interval p′ on the section [k′, k+1] can be obtained using the previously calculated travel time in the time period [k,k′], so that when the vehicle leaves the road section can be derived. The road section [k,k′] is taken as an example:

a location x* and a time t* of the vehicle leaving the rectangular region {s_{k,k′},p} can be calculated as follows:

$$\{ {x}^{*} , {t}^{*} \} = \{ \begin{matrix}\{ {x}_{1} , \frac{( {x}_{1} - {x}^{0} )}{v ( {s}_{k , {k}^{′}} , p )} + {t}^{0} \} & \begin{matrix}When v ( {s}_{k , {k}^{′}} , p ) \cdot ( {t}_{1} - {t}^{0} ) + \\ {x}^{0} > {x}_{1}\end{matrix} \\ \{ v ( {s}_{k , {k}^{′}} , p ) \cdot ( {t}_{1} - {t}_{0} ) + {x}^{0} , {t}_{1} \} & Other\end{matrix} . \qquad ( 5 )$$

A driving trajectory x(t) of the vehicle departing from the time interval p on the road section sₖ can be calculated through the method as follows:

x(t)=v(s_{k,k′},p)·(t−t_{{s}_{_{k,k′}}_{,p}}⁰)+x_{{s}_{_{k,k′}}_{,p}}⁰ (6).

As shown in FIG. 7, a location and time {x_{{s}_{_{k,k′}}_{,p}}⁰,t_{{s}_{_{k,k′}}_{,p}}⁰} of the vehicle entering from the space-time grid unit {s_{k,k′},p}, and a location and time {x_{{s}_{_{k,k′}}_{,p+1}}*,t_{{s}_{_{k,k′}}_{,p+1}}*} of the vehicle leaving from another space-time grid unit {s_{k,k′},p+1} can be calculated by formulas (5) and (6). Therefore, the travel time of the vehicle on the entire road section s_{k,k′} is Travel Time(s_{k,k′})=t_{{s}_{_{k,k′}}_{,p+1}}*−t_{{s}_{_{k,k′}}_{,p}}⁰; when the entire journey contains multiple road sections, it is only necessary to calculate the travel time of the vehicle on each road section, and then sum the travel time, thus being capable of estimating the full travel time of the vehicle in the whole journey. Because the vehicles entering the road from the same node in the same time interval have similar trajectory from a macroscopic view, a mean driving trajectory of these vehicles can be calculated by only obtaining a mean driving velocity of these vehicles in each space-time grid.

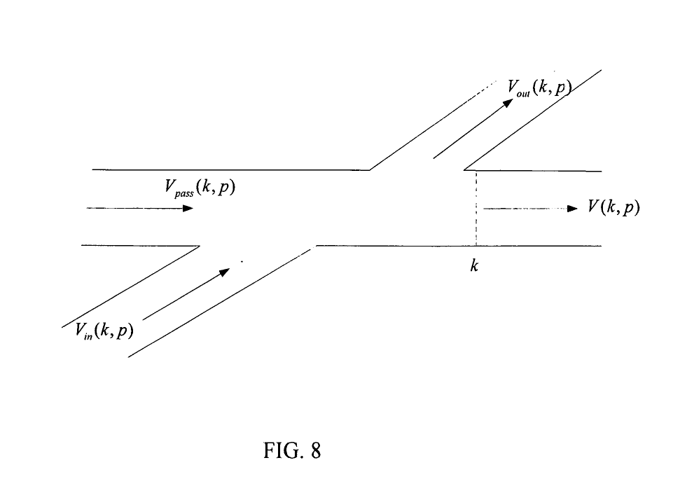

A traffic flow on the toll road section is as shown in FIG. 8. A traffic flow V(k,p) passing by a node section k(k=1, 2, 3, . . . , K−1) is equal to a traffic flow Vᵢₙ(k,p) entering the road from the node section k in the current time interval p plus a traffic flow Vₚₐₛₛ(k,p) entering from all the nodes before the node k and passing by the node k and minus a traffic flow Vₒᵤₜ(k,p) leading the road from the node section k, i.e.:

V(k,p)=(k p)+Vᵢₙ(k,p)+Vₚₐₛₛ(k,p)−Vₒᵤₜ(k,p) (7).

In the formula (7), if there is no exit ramp on the road section, set Vₒᵤₜ(k,p)=0, and if there is no entry ramp on the road section, set Vᵢₙ(k,p)=0.

Since the traffic flow of each road section contains a variety of vehicle models (the system is divided into five models), while the driving velocities of the variety of vehicle models on the road section are different, and the road occupation degrees of different types of vehicles are different, it is necessary to convert vehicles of different models into standard cars with a conversion factor when calculating the traffic flow, therefore:

$$\begin{matrix}{V}_{in} ( k , p ) = {\sum }_{veh = 1}^{5} {w}_{veh} \cdot {V}_{in} ( k , p , veh ) & ( 8 ) \\ {V}_{pass} ( k , p ) = {\sum }_{veh = 1}^{5} {w}_{veh} \cdot {V}_{pass} ( k , p , veh ) & ( 9 ) \\ {V}_{out} ( k , p ) = {\sum }_{veh = 1}^{5} {w}_{veh} \cdot {V}_{out} ( k , p , veh ) . & ( 10 )\end{matrix}$$

In the formulas (8) to (10), veh(veh=1, 2, 3, 4, 5) denotes the vehicle model, and wᵥₑₕ is the vehicle model conversion factor. The conversion factor is as shown in Table 1. Vᵢₙ(k,p,veh) is the traffic flow of entering for the vehicles of the same vehicle models, Vₒᵤₜ(k,p,veh) is the traffic flow of leaving for the vehicles of the same vehicle models, and Vₚₐₛₛ(k,p,veh) is the traffic flow for the vehicles of the same vehicle models to pass through the node section k.

In particular, Vᵢₙ(k,p,veh) and Vₒᵤₜ(k,p,veh) can be obtained by counting the number of vehicles of various vehicle models entering and leaving in the time interval p recorded in the statistical toll data, while Vₚₐₛₛ(k,p,veh) needs to be obtained by calculating the traffic flow passing the node k in the time interval p through the traffic flow of all the nodes entering the road before the node k.

TABLE 1
Vehicle model conversion factor (Technical Standard of Highway
Engineering JTGB01-2014)

| | Vehicle model | | | | |
|---|---|---|---|---|---|
| | 1 | 2 | 3 | 4 | 5 |
| Conversion factor | 1.0 | 1.0 | 1.5 | 2.5 | 4.0 |
| wᵥₑₕ | | | | | |

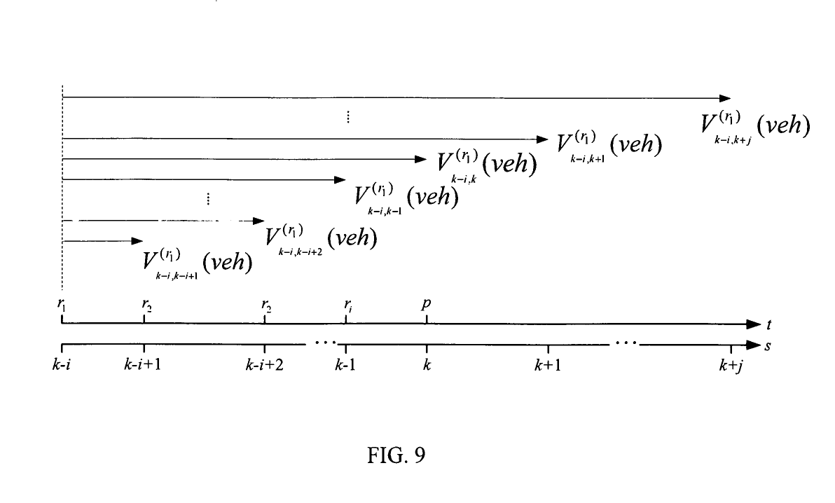

The time required for the vehicle entering from a certain node to reach other node sections can be accurately estimated through the road section travel time estimating method above, so that the location of the traffic flow in each time interval can be estimated, and then the traffic flow of each road section can be estimated. As shown in FIG. 9, there are i(i=1, 2, 3, . . . ) nodes in front of an entry k and J nodes behind the entry k. Vehicle flows of vehicle models veh(veh=1, 2, 3, 4, 5) departing from the node k−i in a certain time interval rᵢ can be deemed as i+j traffic flows that respectively arrive at the i+j nodes behind the node k−i. The traffic flows entering from the node k−i and leaving from the node k will not pass through the node k. It is assumed that the vehicle flow V_{k-i,k}^{(r}^{₁}⁾(veh) denotes the vehicle flow of the vehicle model veh departing from the node k−i and ending at the node k in the time interval rᵢ, the vehicle flow arrives at the node k in Δt, and the time interval located is p when the vehicle flow arrives, i.e., p=r+Δt; and it is assumed that velocities of the vehicle flows departing from the node k−i in each road section are identical, then a vehicle flow departing from the node k−i in the time interval r₁ and just passing by the time interval p is V_{Pass}_{_}ₖ^{(r}^{₁}⁾(k−i,p,veh):

V_{Pass}_{_}ₖ^{(r}^{₁}⁾(k−i,p,veh)=V_{k-i,k+1}^{(r}^{₁}⁾(veh)+V_{k-i,k+1}^{(r}^{₁}⁾(veh)+ . . . +V_{k-i,k+j}^{(r}^{₁}^{)′}(veh) (11).

Vₚₐₛₛ(k,p,veh) can be obtained by calculating the sum of all the traffic flows departing from i stations before the node k to the time interval p and passing by the node k:

Vₚₐₛₛ(k,p,veh)=Vₚₐₛₛ_{_}ₖ^{(r}^{₁}⁾(k−i,p,veh)+Vₚₐₛₛ_{_}ₖ^{(r}^{₂}⁾(k−i+1,p,veh)+ . . . +Vₚₐₛₛ_{_}ₖ^{(r}^{ᵢ}⁾(k−1,p,veh) (12).

In the formula (12), r₁, r₂, r₃, . . . , respectively denote the time intervals for the vehicle flows to depart from the nodes k−i, k−i+1, . . . , k−1 before the node k, and p is just the time interval in which the vehicles flow departing from the nodes k−i, k−i+1, . . . , k−1 in the time intervals r₁, r₂, r₃, . . . , to the node k.

(3) Road Section Travel Velocity

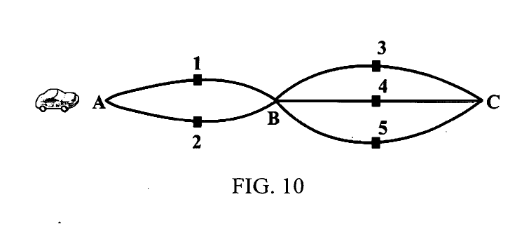

The road section travel velocity is a driving velocity between each section of the toll road. As shown in FIG. 10, there are two routes from A to B, and three routes from B to C, and 5.8 G route identification stations 1, 2, 3, 4, and 5 are respectively arranged on ambiguous routes. The distances from the toll road exit and entry to the identification stations and the 5.8 G route identification station are constant and known. From the above calculation, the vehicle travel time between any two points is known. A distance between the 5.8 G route identification station 1 and 3 is set as L₁₃, and the travel time of a vehicle i between the 5.8 G route identification stations 1 and 3 is set as t₁₃ⁱ, then

a mean travel time of all the vehicles between the 5.8 G route identification stations 1 and 3 is:

$${T}_{13} = \frac{{\sum }_{i = 1}^{N} {t}_{13}^{i}}{N} ; \qquad ( 13 )$$

a travel velocity of the vehicle i between the 5.8 G route identification stations 1 and 3 is:

$${v}_{13}^{i} = \frac{{L}_{13}}{{t}_{13}^{i}} ; \qquad ( 14 )$$

and

a mean travel velocity of all the vehicles between the 5.8 G route identification stations 1 and 3 is:

$${V}_{13} = \frac{{L}_{13}}{{T}_{13}} = \frac{{NL}_{13}}{{\sum }_{i = 1}^{N} {t}_{13}^{i}} . \qquad ( 15 )$$

In particular, T₁₃ is the mean travel time of all the vehicles between the 5.8 G route identification stations 1 and 3, t₁₃ⁱ is the travel time of the vehicle between the 5.8 G route identification stations 1 and 3, v₁₃ⁱ is the travel velocity of the vehicle between the 5.8 G route identification stations 1 and 3, V₁₃ is the mean travel velocity of all the vehicles between the 5.8 G route identification stations 1 and 3, L₁₃ is the distance between the 5.8 G route identification stations 1 and 3, and N is a number of all the vehicles passing by between the 5.8 G route identification stations 1 and 3.

(4) Mean Driving Distance

The actual traveling route of each vehicle can be determined according to the entry information and route information of the vehicle on the toll road obtained by the toll road exit and entry toll lane systems and the 5.8 G route identification stations at the ambiguous routes, thus obtaining the driving distance of the vehicle on the toll road, and obtaining a mean driving distance of all the vehicles according to the driving distances of the vehicles:

$$\overline{{L}_{k}} = \frac{{\sum }_{i = 1}^{N} {L}_{ki}}{N} . \qquad ( 16 )$$

In particular, L̅ₖ̅ is a mean driving distance of vehicles of model k, Lₖᵢ is a driving distance of an i^{th} vehicle in the vehicles of model k, N is a total number of vehicles of model k, and k is the vehicle model (such as large vehicles, passenger cars, freight cars, etc.).

(5) Traffic State Determination

Traffic states of toll roads are smooth, crowded, blocked, etc. When the traffic states in the road sections become worse or congested, it often means a traffic congestion or a traffic event. In this case, the road sections need to be promptly controlled and governed.

When the traffic congestion or the traffic event occurs, the travel time of the vehicles in the road section will increase or the mean travel velocity will decrease. The larger the increase or decrease trend is, the more serious the traffic congestion between the road sections is. Meanwhile, the saturation in the road section will increase. The road section saturation is obtained according to the estimation of the traffic flow of the road section and the analysis of the traffic capacity analysis of the road section. The greater the saturation is, the more serious the traffic congestion between the road sections is. By comparing the vehicle travel time or the mean travel velocity and the road section saturation in the road sections, the traffic states of the road sections can be effectively determined.

(6) Vehicle Location Tracking

When the vehicle is driving on the toll road, the 5.8 G route identification station receives the entry information data of the on-board OBU and the dual-frequency pass card, and can obtain information such as a license plate number and a license plate color of the vehicle. The vehicle location is tracked by calculating and determining the driving distance of the vehicle in next road section at a certain moment according to the travel velocity and travel time of the vehicle in last road section, thus determining the vehicle location in next road section, and providing powerful support for toll road regulators to track illegal vehicles and conduct traffic control.

(7) Vehicle Model/Vehicle Weight Distribution Statistics

When the vehicle enters the toll station, vehicle model identification and freight car weighing are conducted at the entry of the toll station. When the vehicle passes by the 5.8 G route identification station, the vehicle model information and vehicle weight information are uploaded to the 5.8 G route identification station through the OBU and the dual-frequency pass card. The model distribution of vehicles in any section of the toll road can be obtained through the information analysis of the 5.8 G route identification station, and the vehicle model traffic distribution and weight distribution analysis of large vehicles such as large freight cars, large passenger cars can be used as references for toll road administrative authorities to conduct highway maintenance and road repair.

(8) Bluetooth Module Voice Reminding

The information, such as a traffic flow, a traffic state, a travel time, etc., on the road can be clearly obtained according to various information collected and processed by the traffic information processing system, and the two-way wireless communication is implemented through the 5.8 G route identification station, and the OBU and the dual-frequency pass card. The above information is transferred to an OBU or a dual-frequency pass card of a vehicle of a road user, and a Bluetooth module inside the OBU or the dual-frequency pass card is connected to an in-vehicle multimedia terminal (such as a smartphone, a smart bracelet, or an on-board multimedia) via a wireless network, to provide traffic guidance information in real-time, and remind the traffic state information of the ahead road by a voice/image according to the actual need of the road user, such as congestion state, travel time, locations of service areas and fuelling stations, etc., to serve the road user in real-time, thus increasing the travelling comfort.

(9) Statistical Analysis of Toll Road Service Area Information

The 5.8 G route identification station can be disposed in the entry and exit of the toll road service area, and the information in the dual-frequency pass card or the OBU can be obtained in real-time through the 5.8 G route identification station. Information such as a flow of passengers and cargos by vehicle models entering and leaving the service area, a distribution proportion of the vehicle models, a length of stay of the vehicle, and a flow change during a certain period of time (year, month, week, and hour) can be counted according to the information in the dual-frequency pass card or the OBU. A changing rule of the flow with the time and a vehicle stay rule can be obtained through the analysis on the above information. A flow of passengers and cargos by vehicle models and a vehicle stay time in next time period can be predicted according to these rules, and information such as an operating income of the service area, and required gasoline and living materials can be obtained by estimation, so as to provide guidance to govern the toll road service area.

The embodiment of the present invention has been described in detail as above, but the contents disclosed are merely one of the best embodiments of the present invention, and cannot be deemed as a limitation to the implementation scope of the present invention. Any simple modifications, and equivalent changes and embellishments made to the above embodiments according to the technical essence of the invention without departing from the contents of the present invention shall all fall within the scope of protection of the present application.

1. A toll road network traffic information collection and guidance system based on a route identification system, comprising toll road exit and entry toll lane systems, a networked toll center system, a 5.8 G route identification station, a 5.8 G route identification station monitoring system, a dual-frequency pass card for manual toll collection (MTC) vehicles, an on-board unit (OBU) and a non-cash payment card for electronic toll collection (ETC) vehicles, an in-vehicle multimedia terminal and a traffic information processing system,
wherein the vehicle passes by the 5.8 G route identification station in a free-flow state, and the 5.8 G route identification station is configured to conduct a two-way wireless communication with the dual-frequency pass card or the OBU in the vehicle through a 5.8 GHz frequency band to receive information in the dual-frequency pass card or the OBU, and store, count, estimate and predict such information, and launch identification information and traffic information;
the dual-frequency pass card or the OBU is configured to receive and store information launched by the 5.8 G route identification station, and wirelessly transfer the traffic information to the in-vehicle multimedia terminal through a built-in wireless transmission module; and
the traffic information processing system is configured to integrate information collected and processed by the 5.8 G route identification station in real-time through the 5.8 G route identification station monitoring system with exit and entry information collected and processed by the toll road exit and entry toll lane systems in real-time through the networked toll center system, count, estimate and predict the integrated information in combination with historical data, then wirelessly transmit the traffic information estimated and predicted by the traffic information processing system or the 5.8 G route identification station to an in-vehicle multimedia terminal in a vehicle at a demanded location.

2. The toll road network traffic information collection and guidance system based on the route identification system according to claim 1,
wherein the dual-frequency pass card is a pass card that integrates a 13.56 MHz non-contact IC card and a 5.8 GHz radio frequency identification (RFID) card into a whole by a card internal circuit, and the dual-frequency pass card internally comprises a micro control unit (MCU), a power module, a storage unit module, a 5.8 G transceiver, a Mifare-one card, a Bluetooth module, and a wake-up circuit module, and
the MCU is separately connected to each of the other modules for controlling a normal operation of each module;
the power module is configured to provide power for the MCU, the 5.8 G transceiver, the storage unit module, the wake-up circuit module and the Bluetooth module;
the dual-frequency pass card receives and transmits information during a wake-up time, and the wake-up circuit module wakes up for a certain period of time after receiving a signal of a 13.56 MHz or 5.8 GHz frequency band, and completes reading and writing entry and exit information and route information;
wherein at the toll road entry toll lane system, the Mifare-one card in the dual-frequency pass card and a Mifare reader-writer implement a two-way communication to write the entry information;
on the toll road, the 5.8 G transceiver of the dual-frequency pass card can receive identification station information comprising an ID number, a driving direction and timestamp information of the identification station sent by the 5.8 G route identification station, and write the information into the Mifare-one card and the storage unit module under a coordination of the MCU, and transmits the entry information in the storage unit module and information of the 5.8 G route identification station passing by to the 5.8 G route identification station;
at the toll road exit toll lane system, the entry information in the dual-frequency pass card and the information of the 5.8 G route identification station passing by are read out through the Mifare reader-writer; and the dual-frequency pass card can be wirelessly connected to the in-vehicle multimedia terminal through an internal Bluetooth module or WIFI module of the dual-frequency pass card.

3. The toll road network traffic information collection and guidance system based on the route identification system according to claim 1,
wherein a 5.8 G transceiver of the dual-frequency pass card and a 5.8 G transceiver of the OBU are configured to receive ahead traffic information sent by the 5.8 G route identification station, and a Bluetooth module or a WIFI module in the dual-frequency pass card and a Bluetooth module or a WIFI module in the OBU are wirelessly connected to the in-vehicle multimedia terminal, to provide real-time traffic state and service facility guidance information ahead the vehicle through a voice and/or a real-time traffic state graph;
the in-vehicle multimedia terminal comprises a smartphone, a smart earphone, a smart bracelet and an on-board multimedia terminal;
the on-board multimedia terminal can be connected to an on-board diagnosis computer, and can collect vehicle driving state information; and
the dual-frequency pass card and the OBU can receive vehicle running state information collected by the on-board multimedia terminal through the Bluetooth module or the WIFI module.

4. The toll road network traffic information collection and guidance system based on the route identification system according to claim 1,
wherein the information in the dual-frequency pass card or the OBU received by the 5.8 G route identification station comprises an ID number of the dual-frequency pass card or the OBU, an entry location and time, a vehicle model and a weight, and an ID number, a driving direction and timestamp information of the 5.8 G route identification station passing by;
the entry information further comprises a license plate number, vehicle color information and a number of vehicle axle wheels in the dual-frequency pass card, a license plate number, a license plate color, a vehicle user type, a vehicle size, a number of axles, a number of wheels, a wheelbase, and a vehicle load/number of seats, vehicle characterization and vehicle engine number information in the OBU; and
the information in the dual-frequency pass card or the OBU received by the 5.8 G route identification station further comprises vehicle running information comprising a vehicle engine number, exhaust emissions, a vehicle velocity, an accelerated velocity, a steering angle, and steering and braking information.

5. The toll road network traffic information collection and guidance system based on the route identification system according to claim 1,
wherein the 5.8 G route identification station is at least disposed on a road section of an unsupported tree structure in a connected graph of a toll road, at the toll road exit toll lane system, the MTC vehicle obtains the information of the 5.8 G route identification station passing by through the dual-frequency pass card to implement a real route identification of the vehicle, and the ETC vehicle obtains the information of the 5.8 G route identification station passing by through the on-board OBU to implement the real route identification of the vehicle.

6. The toll road network traffic information collection and guidance system based on the route identification system according to claim 1,
wherein the 5.8 G route identification station is disposed in an accident blackspot, before an important exit ramp, in a special road section, or in every one to four kilometers of a road section according to real-time requirements on traffic information collection.

7. The toll road network traffic information collection and guidance system based on the route identification system according to claim 1,
wherein the 5.8 G route identification station is served as virtual non-stop exit and entry toll lane systems, when the vehicle enters an identification location of the 5.8 G route identification station, the 5.8 G route identification station is served as the virtual non-stop exit toll lane system, and when the vehicle leaves the identification location of 5.8 G route identification station, the 5.8 G route identification station is served as the virtual non-stop entry toll lane system;
the toll road exit and entry toll lane systems and the virtual non-stop exit and entry toll lane systems are served as a cloud for information collection and processing, and are configured to utilize the information in the dual-frequency pass card or the OBU or the non-cash payment card at the time of collection, and stored historical data to directly estimate and predict a travel time of passengers and cargos by vehicle models, and a flow of passengers and cargos by vehicle models from the entry to the exit, from the entry to the 5.8 G route identification station, from the 5.8 G route identification station to the 5.8 G route identification station, and from the 5.8 G route identification station to the exit of the toll road network, collected by the cloud in the time period; and
the traffic information processing system is served as a cloud center for integrating vehicle data of the same road section in the same time period according to processing results of each cloud, and estimating a traffic flow, a velocity, a traffic density, a traffic state and a travel time of passengers and cargos by vehicle models of each section in the toll road network, and predicting an origin-destination (OD) traffic, a travel time, and a traffic condition of passengers and cargos by vehicle models in the entire network.

8. The toll road network traffic information collection and guidance system based on the route identification system according to claim 7,
wherein estimating the travel time is to divide a toll road section into a basic road section by adjacent toll stations, if the 5.8 G route identification station exists in a certain road section, then the road section is subdivided by the 5.8 G route identification station, which is specifically divided as follows:
from an upstream toll station to the 5.8 G route identification station, and from the 5.8 G route identification station to a downstream toll station, using exit and entry time difference information in the dual-frequency pass card or the OBU or the non-cash payment card collected in real-time by the toll road exit and entry toll lane systems and the 5.8 G route identification station to remove disturbance data, obtain all the travel time by vehicle types from the entry to the exit, from the entry to the 5.8 G route identification station, from the 5.8 G route identification station to the 5.8 G route identification station, and from the 5.8 G route identification station to the exit of the toll road in different time intervals, and then perform weighted stacking calculation on the travel time by vehicle types of different exits and entries according to a principle that the travel time is more accurate when a distance between ODs on a line is longer and according to a method that a weight is larger when a distance between the road sections is longer, and stack the travel time of all the road sections in the entire toll road to accurately estimate the travel time of passengers and cargos by vehicle models between all the ODs in the toll road network;
in the meanwhile, the cloud center uses regression analysis to study a correlation between the vehicle travel time and vehicle models, and between a toll road section location and a time period variable according to massive historical data and real-time travel time estimation, and then determines an impact factor of the variable to the travel time according to a correlation coefficient of the variable and the travel time, and implements prediction of vehicle travel time in a short time at next moment of the toll road through calculating the impact factor and the historical travel time;
estimating the traffic flow of the road section is to first estimate a mean driving trajectory of the vehicle, and then convert different vehicle models into standard models based on different road possession degrees of different vehicle models, and use the calculated basic road travel time to linearize velocities of the vehicle on different road sections, wherein an initial velocity is a tail end velocity of a last vehicle driving section, and a terminal velocity is an initial velocity of a next road section, location information of the vehicle at any time can be obtained by calculating the driving trajectory of the vehicle, thereby obtaining a number of existing vehicles on any road section on the road, a number of vehicles in the virtual non-stop exit toll lane system and an exit ramp drive-off road section in the road sections, a number of vehicles in the upstream virtual non-stop entry toll lane system and an entry ramp entering road section in the road sections, so that a traffic flow of any road section can be obtained according to the number of vehicles passing by the same section in the same time interval;
the velocity is calculated according to all the distances from the entry to the exit, the entry to the 5.8 G route identification station, the 5.8 G route identification station to the 5.8 G route identification station, and the 5.8 G route identification station to the exit of the toll road, and the travel time needed for the vehicle to pass through the distance; and
the traffic state is obtained by evaluating and analyzing the travel time and velocity of the road section obtained in real-time on the toll road network and road section saturation obtained by estimating the traffic flow of the road section and a traffic capacity analysis of the road section, thereby obtaining real-time dynamic traffic state information.

9. The toll road network traffic information collection and guidance system based on the route identification system according to claim 1,
wherein the 5.8 G route identification station is disposed at an entry and an exit of a toll road service area to count and analyze a flow of passengers and cargos by vehicle models and a vehicle stay rule in the service area through the information in the dual-frequency pass card or the OBU obtained by the 5.8 G route identification station, and predict the flow of passengers and cargos by vehicle models and an operating income in the service area.

10. The toll road network traffic information collection and guidance system based on the route identification system according to claim 1,
wherein the 5.8 G route identification station is also provided with a high-definition license plate identification system which matches a captured vehicle license plate number and a captured license plate color with the vehicle information in the dual-frequency pass card or the OBU obtained by the 5.8 G route identification station to judge whether there is a dual-frequency pass card or an OBU in the vehicle, how many dual-frequency pass card in the vehicle, and whether the vehicle information is matched with the information of the vehicle captured, and is applied to a toll road anti-escape system.

11. The toll road network traffic information collection and guidance system based on the route identification system according to claim 3,
wherein the information in the dual-frequency pass card or the OBU received by the 5.8 G route identification station comprises an ID number of the dual-frequency pass card or the OBU, an entry location and time, a vehicle model and a weight, and an ID number, a driving direction and timestamp information of the 5.8 G route identification station passing by;
the entry information further comprises a license plate number, vehicle color information and a number of vehicle axle wheels in the dual-frequency pass card, a license plate number, a license plate color, a vehicle user type, a vehicle size, a number of axles, a number of wheels, a wheelbase, and a vehicle load/number of seats, vehicle characterization and vehicle engine number information in the OBU; and
the information in the dual-frequency pass card or the OBU received by the 5.8 G route identification station further comprises vehicle running information comprising a vehicle engine number, exhaust emissions, a vehicle velocity, an accelerated velocity, a steering angle, and steering and braking information.
